(19) United States
(12) Patent Application Publication
(10) Pub. No.: US 2009/0079770 A1
(43) Pub. Date: Mar. 26, 2009

(54) RECORDING APPARATUS

(75) Inventor: Katsuhito SUZUKI, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/237,200

(22) Filed: Sep. 24, 2008

(30) Foreign Application Priority Data
Sep. 25, 2007 (JP) 2007-246677

(51) Int. Cl. B41J 3/00

(52) U.S. Cl. 347/2

(57) ABSTRACT

A recording apparatus which transfers a recording medium having a lenticular lens and performs recording on the recording medium to be transferred includes a linear engaging portion disposed on a supporting surface of a supporting unit for supporting the recording medium to be transferred to engage with the lenticular lens in a predetermined transfer direction.

### BACKGROUND

1. Technical Field

The present invention relates to a recording apparatus for recording on a recording medium having a lenticular lens.

2. Related Art

Currently, such a recording medium is known which has a lenticular lens overlapped with a recording layer and provides an image recorded on the recording layer as a solid image or a variable picture image having variable shapes or the like of the image according to viewing angles via the lenticular lens. For providing the image recorded on the recording medium as a predetermined solid image or a variable picture image, the recording position on the recording layer needs to be matched with the lens arrangement of the lenticular lens with high accuracy. For this purpose, Japanese Patent No. 3,471,930 shows a system for detecting the position of the lenticular lens by using a sensor and performing recording at a desired position based on the detection result, for example. Also, JP-A-2007-130769 proposes a technology for preventing shift of the recording medium placed on a transfer tray from a predetermined position on the tray to increase accuracy of the recording position.

According to the system disclosed in Japanese Patent No. 3,471,930, however, the sensor needs to be equipped and thus the cost rises. According to the technology disclosed in JP-A-2007-130769, the shift of the recording medium with respect to the transfer tray can be prevented, but the recording position accuracy cannot be raised when the transfer tray is transferred while inclined to the transfer direction.

### SUMMARY

Various embodiments provide a recording apparatus capable of increasing recording position accuracy by a simple structure.

According to at least one embodiment, there is provided a recording apparatus which transfers a recording medium having a lenticular lens and performs recording on the recording medium to be transferred and includes a linear engaging portion disposed on a supporting surface of a supporting unit for supporting the recording medium to be transferred to engage with the lenticular lens in a predetermined transfer direction.

According to the recording apparatus having this structure, the transfer direction of the recording medium at the time of transfer may be kept constant, and the accuracy of the recording position on the recording medium may be increased.

In the recording apparatus, the number of the engaging portion may be plural and an integral number times larger than the arrangement pitch of the lenticular lens. According to the recording apparatus having this structure, the lenticular lens of the recording medium engages with the engaging portions. Thus, the transfer direction of the recording medium may be securely maintained, and the accuracy of the recording position on the recording medium may be increased.

In the recording apparatus, the engaging portions may be formed throughout the recording medium in the width direction of the recording medium with the same pitch as that of the lenticular lens. According to the recording apparatus having this structure, the entire area of the lens surface of the recording medium in its width direction engages with the engaging portions. Thus, the transfer direction of the recording medium may be securely maintained, and the accuracy of the recording position on the recording medium may be further increased.

The recording apparatus may further include a pressing unit which presses the recording medium against the support surface. According to the recording apparatus having this structure, the engagement with the lenticular engaging portions of the recording apparatus is secured by the pressing unit, the transfer direction of the recording medium may be securely maintained, and the accuracy of the recording position on the recording medium may be further increased.

In the recording apparatus, the pressing unit may be a rotation roller which rotates in the transfer direction of the recording medium. According to the recording apparatus having this structure, the rotation roller rotates in the transfer direction of the recording medium. Thus, the driving force necessary for transferring the recording medium may be reduced.

The recording apparatus may further include a displacement mechanism which displaces the engaging portion in a direction perpendicular to the transfer direction along the supporting surface. According to the recording apparatus having this structure, the position of the recording medium may be matched with a predetermined recording position.

The recording apparatus may further include a rotation mechanism which rotates the engaging portion along the supporting surface. According to the recording apparatus having this structure, the engagement direction of the engaging portions and the lenticular lens may be matched with the transfer direction of the recording medium.

In the recording apparatus, the engaging portion may be formed by the same component as that of the lenticular lens of the recording medium. According the recording apparatus having this structure, the engaging portions may be easily produced.

According to at least one embodiment, transfer accuracy of a recording medium having a lenticular lens may be increased by a simple structure.

### BRIEF DESCRIPTION OF THE DRAWINGS

The invention will be described with reference to the accompanying drawings, wherein like numbers reference like elements.

FIG. 1 is a rear perspective view of a recording apparatus according to a first embodiment of the invention.

FIG. 2 illustrates an enlarged portion R shown in FIG. 1.

FIG. 3 is a rear perspective view of a recording apparatus according to a second embodiment of the invention.

FIG. 4 is a rear perspective view of a recording apparatus according to a third embodiment of the invention.

FIG. 5 shows recording contents on an inspection image.

FIG. 6 shows an inspection image as viewed from a lenticular lens.

FIG. 7 is a rear perspective view of a recording apparatus according to a fourth embodiment of the invention.

FIG. 8 is a cross-sectional view taken along a cut line A-A in FIG. 7.

FIG. 9 is a cross-sectional view taken along a cut line B-B in FIG. 7.

FIG. 10 is a rear perspective view of a recording apparatus in a fifth embodiment of the invention.

FIG. 11 is a cross-sectional view taken along a cut line A-A in FIG. 10.

FIG. 12 is a rear perspective view of a recording apparatus in a sixth embodiment of the invention.

FIG. 13 is a cross-sectional view taken along a cut line A-A in FIG. 12.

FIG. 14 is a rear perspective view of a recording apparatus in a seventh embodiment of the invention.

FIG. 15 is a rear perspective view of a recording apparatus in an eighth embodiment of the invention, showing removal of a sheet guide from the recording apparatus.

FIG. 16 illustrates attachment of the sheet guide in the recording apparatus shown in FIG. 15.

FIG. 17 illustrates a sheet guide attachment portion of the recording apparatus shown in FIG. 15 on the housing side.

FIG. 18 illustrates an attachment portion of the recording apparatus shown in FIG. 15 to be attached to the housing on the sheet guide side.

FIG. 19 illustrates shapes of engaging portions in a modified example.

### DESCRIPTION OF EXEMPLARY EMBODIMENTS

### First Embodiment

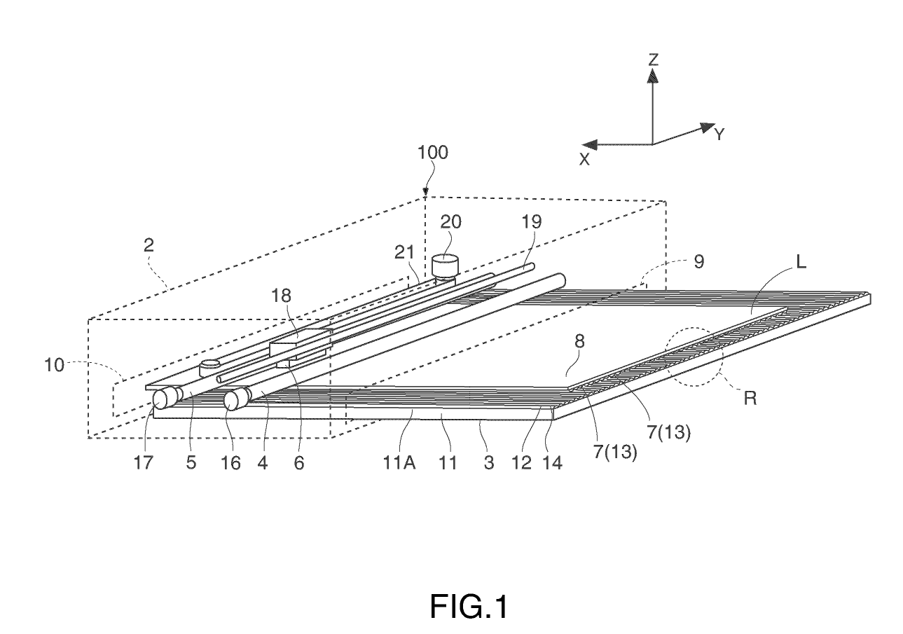

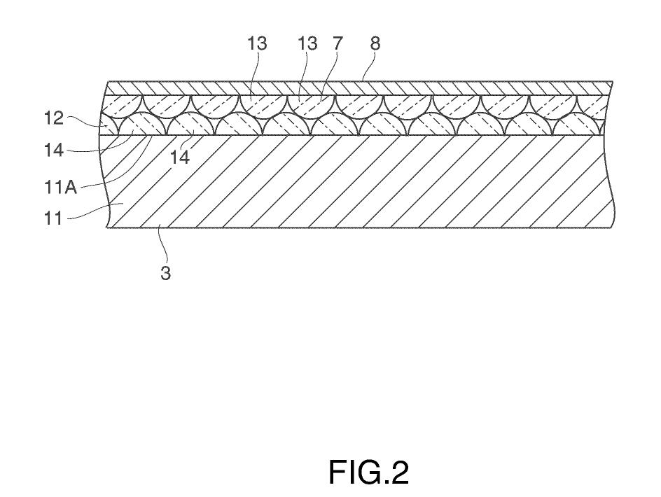

A recording apparatus 100 according to the first embodiment of the invention is hereinafter described with reference to FIGS. 1 and 2.

FIG. 1 is a perspective view schematically illustrating the structure of the recording apparatus 100 as viewed from the rear of the recording apparatus 100. FIG. 2 illustrates an enlarged part R shown in FIG. 1. In FIG. 1, a direction indicated by an arrow X as a traveling direction of a lens sheet L as a recording medium corresponds to a frontward direction (front direction), and the opposite direction corresponds to a rearward direction (rear direction) Also, a direction indicated by an arrow Y as a right direction from the rear toward the front corresponds to a rightward direction (right direction), and the opposite direction corresponds to a leftward (left direction) direction.

Furthermore, a direction indicated by an arrow Z corresponds to an upward direction (upper direction), and the opposite direction corresponds to a downward direction (lower direction) in the following description.

The recording apparatus 100 includes a housing 2 as an outer casing, a sheet guide 3 as a supporting unit for supporting a lens sheet L as a recording medium from the lower side, a sheet feed roller 4 and a sheet discharge roller 5 for transferring the lens sheet L placed on the seat guide 3 from the rear toward the front, and a recording head 6 for performing recording on the lens sheet L, and other components.

The lens sheet L has a lenticular lens 7 on one surface of a transparent resin sheet, and an image forming layer 8 on the other surface of the sheet. The lens sheet L is designed such that an image recorded on the image forming layer 8 may be visually recognized via the lenticular lens 7. When an image having parallax and recorded on the image forming layer 8 in correspondence with the arrangement pitch, focus distance and the like of the lenticular lens 7 is viewed from the side of the lenticular lens 7, for example, this image is visually recognized as an image having solidity or an image variable according to viewing angle. The lens sheet L may be designed such that an image is directly recorded on a resin portion of the surface opposite to the surface having the lenticular lens 7 without the image forming layer 8 formed on the lens sheet L.

A sheet feed opening 9 through which the lens sheet L is supplied into the housing 2 is formed on the rear side surface of the housing 2, and a sheet discharge opening 10 through which the lens sheet L from the sheet feed opening 9 is discharged is formed on the front side surface. The lens sheet L supplied from the sheet feed opening 9 into the recording apparatus 100 is transferred toward the front by the sheet feed roller 4 and the sheet discharge roller 5, and then discharged to the outside of the recording apparatus 100 through the sheet discharge opening 10 after recording by the recording head 6.

The sheet guide 3 is provided below the sheet feed roller 4 and the sheet discharge roller 5, and has a rectangular plate-shaped body as a whole. The sheet guide 3 extends from a position projecting toward the rear of the sheet feed opening 9 to a position between the sheet discharge opening 10 and the sheet discharge roller 5 in the front-rear direction. The sheet guide 3 has a width sufficient for supporting the entire width of the placed lens sheet L in the left-right width direction. The sheet guide 3 is attached to the structure such as the housing 2, an internal frame and the like by a not-shown component.

The sheet guide 3 has a plate-shaped substrate 11 formed by resin or the like, and engaging portions 12. The engaging portions 12 provided on an upper surface 11A as a support surface of the substrate 11 for supporting the lens sheet L has the same shapes as those of the lenticular lens 7. More specifically, linear convexes 14 having the same shapes as those of respective lens elements 13 (such as cylindrical lenses) for forming the lenticular lens 7 and having a width larger than that of the lens sheet L are provided in parallel with the lens sheet L with the same pitch as the arrangement pitch of the lenticular lens 7. The longitudinal direction of the convexes 14, that is, the bus line (ridge line) direction of the convexes 14 extends along a direction perpendicular to a predetermined transfer direction of the lens sheet L, that is, a direction perpendicular to the sheet feed roller 4 and the sheet discharge roller 5.

According to this embodiment, the engaging portions 12 are formed by the same component as that of the lenticular lens 7. That is, the engaging portions 12 are formed on the substrate 11 by affixing the lens sheet L having the surface convexed upward onto the upper surface of the substrate 11. Thus, the engaging portions 12 may be easily formed on the substrate 11 by using the lens sheet L in this manner. When the substrate 11 is formed by resin, a mold surface corresponding to the engaging portions 12 is produced on a molding metal in advance such that the engaging portions 12 may be formed integrally with the substrate 11. When the engaging portions 12 are formed integrally with the substrate 11 by resin in this manner, friction produced between the lens sheet L and the engaging portion 12 may be reduced by forming the substrate 11 from low-frictional resin material such as fluororesin. Thus, the lens sheet L may be smoothly transferred. Alternatively, the substrate 11 may be formed by metal plate. In this case, the engaging portions 12 may be formed by cutting metal plate.

The sheet feed roller 4 and the sheet discharge roller 5 are disposed before and behind the recording head 6. The sheet feed roller 4 and the sheet discharge roller 5 are rotated by a sheet feed motor 16 and a sheet discharge motor 17, respectively, to transfer the lens sheet L placed on the sheet guide 3 from the rear toward the front.

The recording head 6 is attached to the lower surface of a carriage 18 to function as an ink-jet-type recording head for delivering ink in this embodiment. The carriage 18 is movably supported by a carriage guide 19 extending in the left-right direction, and attached to a timing belt 21 driven by a carriage motor 20. When the timing belt 21 rotates by the driving force of the carriage motor 20 in the left-right direction, the recording head 6 shifts with the carriage 18 in the left-right direction along the carriage guide 19.

Thus, transfer in the sub scanning direction as the transfer direction of the lens sheet L by the sheet feed roller 4 and the sheet discharge roller 5 is controlled. Moreover, shift in the main scanning direction as the shift direction of the recording head 6, that is, shift in the left-right direction is controlled. As a result, the recording head 6 may move to the predetermined position on the lens sheet L to record an image at a desired position on the lens sheet L. The lens sheet L is placed on the sheet guide 3 such that the image forming layer 8 side of the lens sheet L is opposed to the recording head 6, and that the lenticular lens 7 side contacts the engaging portions 12. Thus, the recording head 6 performs recording on the image forming layer 8, and produces a recorded material containing an image recorded on the image forming layer 8 to be visually recognized from the lenticular lens 7 side.

For recording on the lens sheet L by using the recording apparatus 100 having this structure, the lens sheet L is placed on the sheet guide 3 with the lenticular lens 7 side opposed to the engaging portions 12 of the sheet guide 3. Since the engaging portions 12 and the lenticular lens 7 have the same shapes, the lens elements 13 constituting the lenticular lens 7 of the lens sheet L placed on the sheet guide 3 engage with the linear convexes 14 as illustrated in FIG. 2. As a result, the lens sheet L is positioned by the engaging portions 12 in the left-right direction (main scanning direction). In addition, the bus line (ridge line) direction of the convexes 14 extends in the direction perpendicular to the main scanning direction as the predetermined transfer direction of the lens sheet L. During the transfer of the lens sheet L by the sheet feed roller 4 and the sheet discharge roller 5, therefore, the lens sheet L is guided by the engaging portions 12 in the direction perpendicular to the main scanning direction. More specifically, the lens sheet L is transferred with the transfer direction kept constant by disposing the sheet guide 3 in correspondence with the bus line (ridge line) direction of the convexes 14, that is, by disposing the guide direction of the engaging portions 12 in correspondence with the predetermined transfer direction of the lens sheet L. By transferring the lens sheet L with the transfer direction kept constant, recording by the recording head 6 may be performed at a predetermined position on the lens sheet L.

The clearance between the sheet feed roller 4 and the sheet guide 3, and the clearance between the sheet discharge roller 5 and the sheet guide 3 have distances sufficient for applying appropriate pressing force to the lens sheet L from the rollers 4 and 5. Since the engagement between the engaging portions 12 and the lenticular lens 7 is secured by pressing the lens sheet L against the sheet guide 3, the transfer accuracy in the left-right direction during transfer of the lens sheet L, that is, the straightness in transfer of the lens sheet L may be increased.

Particularly, when the lens sheet L is curved in the up-down direction, for example, the engagement between the lenticular lens 7 and the engaging portions 12 is easily separated. Thus, the lens sheet L is pressed against the sheet guide 3 via the sheet feed roller 4 and sheet discharge roller 5 such that the curved lenticular lens 7 is not separated from the sheet guide 3. As a result, the engagement between the lenticular lens 7 and the engaging portions 12 may be maintained. When the lens sheet L is pressed against the sheet guide 3 with strong force, transfer load such as friction between the lens sheet L and the sheet guide 3 increases. In this case, the lens sheet L may not be smoothly transferred. Thus, conditions such as the distance between the sheet feed roller 4 and the sheet guide 3 and the distance between the sheet discharge roller 5 and the sheet guide 3 are determined such that appropriate pressing force capable of securely maintaining the engagement between the lenticular lens 7 and the engaging portions 12 may be generated considering the transfer load at a level not preventing smooth transfer of the lens sheet L.

In this embodiment, for example, the surfaces of the sheet feed roller 4 and the sheet discharge roller 5 are made elastically deformable by covering the peripheries of the sheet feed roller 4 and the sheet discharge roller 5 with thick rubber having elasticity. Also, each of the distances between the sheet feed roller 4 and the sheet guide 3 and between the sheet feed roller 5 and the sheet guide 3 is smaller than the thickness of the lens sheet L. In this structure, the lens sheet L may be pressed against the sheet guide 3 by the sheet feed roller 4 and the sheet discharge roller 5. In this case, the surfaces of the sheet feed roller 4 and the sheet discharge roller 5 at the portions contacting the lens sheet L are elastically deformed to be flat shapes while the lens sheet L passes between the sheet guide 3 and the areas of the sheet feed roller 4 and the sheet discharge roller 5. That is, the lens sheet L is transferred by the rotations of the sheet feed roller 4 and the sheet discharge roller 5 with the lens sheet L pressed by the sheet guide 3 by the reaction force of the elastic deformation. In this case, the lens sheet L may be smoothly transferred with the lenticular lens 7 pressed against the engaging portions 12 with appropriate pressing force by determining the conditions such as elasticity and wall thickness of the rubber and the distances between the sheet feed roller 4 and the sheet guide 3 and between the sheet feed roller 5 and the sheet guide 3.

When the surfaces of the sheet feed roller 4 and the sheet discharge roller 5 are elastically deformable as in this embodiment, the lens sheet L may be transferred with the pressing force discussed above applied thereto while the distances between the sheet guide 3 and the areas of the sheet feed roller 4 and the sheet discharge roller 5 are set at distances sufficient for transferring sheet medium such as copy sheet.

While the sheet medium such as copy sheet has a thickness of about 0.1 mm, the lens sheet L has a thickness of as large as 0.5 mm for the necessity of forming the lenticular lens 7 on the lens sheet L. Thus, this distance may be set at a small distance only enough for transfer of the sheet medium to transfer the sheet medium when the transfer target is a sheet medium. When the transfer target is the thick lens sheet L, the sheet feed roller 4 and the sheet discharge roller 5 at the areas contacting the lens sheet L elastically deform to transfer the lens sheet L with the lens sheet L pressed against the sheet guide 3 by the elastic deformation of the rubber.

Each of the lengths of the sheet feed roller 4 and the sheet discharge roller 5 is larger than the left-right width of the lens sheet L. Thus, a wide range of the lens sheet L is uniformly pressed against the engaging portions 12 so that the engagement between the lenticular lens 7 and the engaging portions 12 may be more securely achieved.

### Second Embodiment

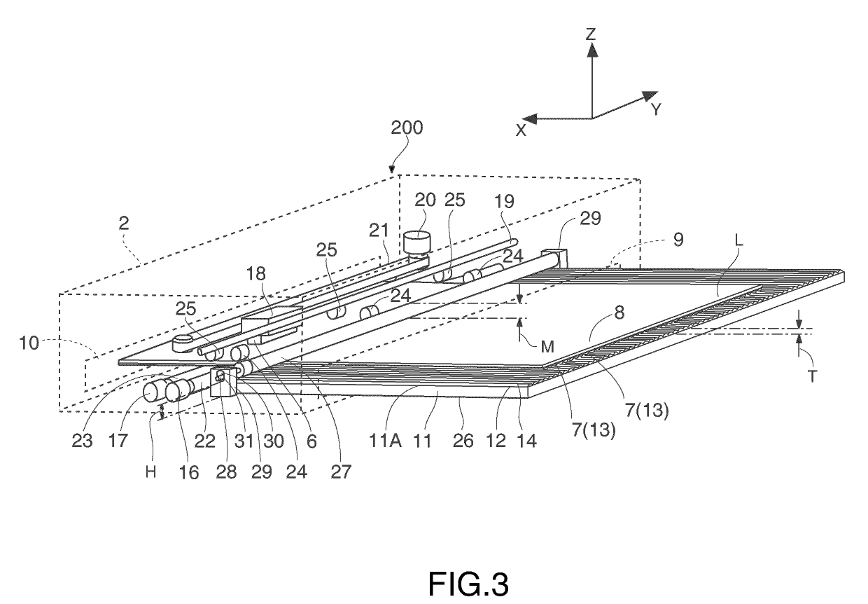

A recording apparatus 200 according to a second embodiment of the invention is now described with reference to FIG. 3.

FIG. 3 is a perspective view schematically illustrating the structure of the recording apparatus 200 as viewed from the rear of the recording apparatus 200. In this figure, reference numbers similar to those in the first embodiment are given to the similar parts, and the same explanation is not repeated.

While the sheet feed roller 4 and the sheet discharge roller 5 are disposed above the lens sheet L to be transferred in the first embodiment, a sheet feed roller 22 and a sheet discharge roller 23 for transferring the lens sheet L are disposed below the lens sheet L to be transferred in the recording apparatus 200 in this embodiment. Three sheet feed following rollers 24 which rotate by following the rotation of the sheet feed roller 22 are disposed in the left-right direction above the sheet feed roller 22. Similarly, three sheet discharge following rollers 25 which rotate by following the rotation of the sheet discharge roller 23 are disposed in the left-right direction above the sheet discharge roller 23. Thus, the lens sheet L is transferred between the sheet feed roller 22 and the sheet feed following rollers 24 and between the sheet discharge roller 23 and the sheet discharge following rollers 25.

A weighing roller 27 for pressing the lens sheet L against the sheet guide 26 is provided behind the sheet feed roller 22. The weighing roller 27 is made of metal such as stainless steel and brass, and has a larger length than the width of the lens sheet L in the left-right direction. A shaft 28 is provided at each of the right and left end surfaces of the weighing roller 27.

The weighing roller 27 is rotatably supported by a bearing hole 30 of a bearing 29 provided in each of the left and right directions of the weighing roller 27 via the shaft 28. The bearing hole 30 has an oblong shape extended in the up-down direction. Thus, the weighing roller 27 is supported by the bearings 29 in such a manner as to shift in the up-down direction.

A sheet guide 26 is provided below the weighing roller 27. While the front end of the sheet guide 3 of the recording apparatus 100 in the first embodiment is disposed before the sheet feed roller 5, the front end of the sheet guide 26 is disposed behind the sheet feed roller 22 and between the sheet feed roller 22 and the weighing roller 27. The structure of the sheet guide 26 included in the recording apparatus 200 is similar to that of the recording apparatus 100 in other parts.

A diameter M of the weighing roller 27 and a height H of a lower end 31 of the bearing hole 30 from the sheet guide 26 are determined such that the distance between the sheet guide 26 and the weighing roller 27 becomes smaller than a distance T between the upper surface of the lens sheet L placed on the sheet guide 26 and the tops of the convexes 14 under the condition in which the shaft 28 of the weighing roller 27 is supported by the lower end 31 of the bearing hole 30. When the lens sheet L is inserted between the weighing roller 27 and the sheet guide 26, the weighing roller 27 is raised by the lens sheet L. Thus, the lens sheet L to be transferred on the sheet guide 26 may be pressed against the sheet guide 26 by the weighing roller 27. When the lens sheet L is transferred toward the front by the sheet feed roller 22 and the sheet discharge roller 23, the weighing roller 27 revolves around the shaft 28 by following the transfer of the lens sheet L. As a result, the lens sheet L may be pressed against the sheet guide 26 while preventing increase in the transfer load of the lens sheet L. Moreover, the lens sheet L is transferred without rubbing against the weighing roller 27.

According to the recording apparatus 200 having this structure, the lens sheet L is transferred along the guide direction with the transfer direction kept constant similarly to the recording apparatus 100. Moreover, the engagement between the lenticular lens 7 and the engaging portions 12 is secured by pressing the lens sheet L against the sheet guide 26 via the weighing roller 27. As a result, the accuracy in the recording position on the lens sheet L may be increased.

Furthermore, the length of the weighing roller 27 is larger than the width of the lens sheet L in the left-right direction. Thus, the lens sheet L may be uniformly pressed against the engaging portions 12 in a wide range, and the engagement between the lenticular lens 7 and the engaging portions 12 may be more secured.

### Third Embodiment

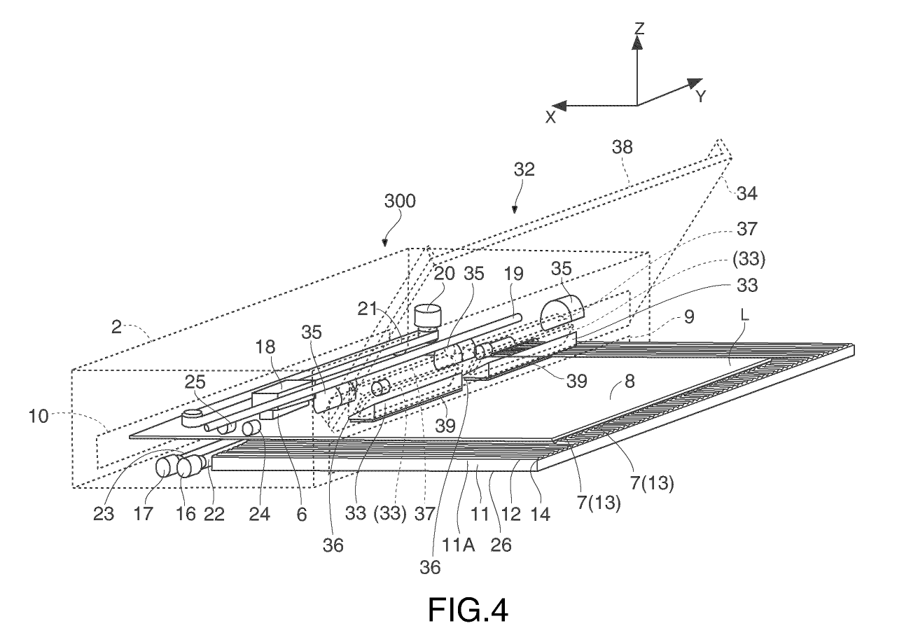

A recording apparatus 300 according to a third embodiment of the invention is now described with reference to FIG. 4.

FIG. 4 is a perspective view schematically illustrating the structure of the recording apparatus 300 as viewed from the rear of the recording apparatus 300. In this figure, reference numbers similar to those in the first and second embodiments are given to the similar parts, and the same explanation is not repeated.

The recording apparatus 300 in this embodiment presses the lens sheet L against the sheet guide 26 by using sheet weights 33 of a sheet feeder mechanism 32. The sheet feeder mechanism 32 has a sheet stacker 34 as a supporting unit, the sheet weights 33, a pickup roller 35, and other components, and picks up each of plural sheets (not shown) stacked on the sheet stacker 34 by using the pickup roller 35. The sheets placed on the sheet stacker 34 except for the sheet drawn by the pickup roller 35 are stopped by the sheet weights 33 such that the sheets do not slip down toward the front.

As illustrated in FIG. 4, each of the two sheet weights 33 is disposed between the three pickup rollers 35 disposed at equal intervals in the left-right direction, and is rotatable around a front end 36 in the up-down direction by a not-shown rotation mechanism. During use of the sheet feeder mechanism 32, that is, when a sheet (not shown) is placed on the sheet stacker 34, the sheet weights 33 are located at positions rotated upward as indicated by dotted lines in FIG. 4. At this position, rear end surfaces 37 of the sheet weights 33 project upward from a sheet carrying surface 38 of the sheet stacker 34 to prevent downward slip of the sheet (not shown) placed on the sheet stacker 34 toward the front.

When the sheet (not shown) is not placed on the sheet stacker 34, that is, when the sheet feeder mechanism 32 is not used, the sheet weights 33 are disposed at lens sheet pressing positions rotated downward as indicated by solid lines in FIG. 4. The lower surfaces of the sheet weights 33 are felt surfaces 39 covered with affixed felt.

At the lens sheet pressing positions, the sheet weights 33 are disposed such that the felt surfaces 39 of the sheet weights 33 are opposed to the sheet guide 26 (or the lens sheet L when the lens sheet L is placed on the sheet guide 26). In this condition, the sheet weights 33 are urged downward by urging unit such as not-shown spring. Thus, under the non-use condition of the sheet feeder mechanism 32, the lens sheet L is pressed against the sheet guide 26 by the sheet weights 33 rotated to the lens sheet pressing positions.

More specifically, the lens sheet L is transferred with the transfer direction kept constant in the guide direction of the engaging portions 12 similarly to the cases of the recording apparatus 100 and the recording apparatus 200 by setting the urging force of the urging unit for urging the sheet weights 33 downward such that heavy braking force is not given to the transfer of the lens sheet L and that the engagement between the lenticular lens 7 of the lens sheet L and the engaging portions 12 may be secured. Thus, recording by the recording head 6 may be performed at a predetermined position. While the lens sheet L is transferred with press by the sheet weights 33, the image forming layer 8 rubs against the felt surfaces 39. In this case, the image forming layer 8 contacting the soft and low-frictional felt surfaces 39 is not damaged.

### Detection of Transfer Angle

Recording may be performed at a predetermined position of the lens sheet L when the sheet guide 3 or 26 is attached to the housing 2 such that the guide direction of the engaging portions 12 extends accurately in the predetermined transfer direction of the lens sheet L, that is, extends orthogonal to the main scanning direction (direction orthogonal to the sheet feed roller 4 or 22 and the sheet discharge roller 5 or 23. However, the lens sheet L on the sheet guide 3 or 26 is obliquely transferred when the sheet guide 3 or 26 is attached to the housing 2 with the guide direction of the engaging portions 12 not orthogonal to the main scanning direction. In this case, the lens sheet L is transferred while shifted toward either the left or the right due to the oblique transfer, and thus recording may not be performed at the predetermined position of the lens sheet L. However, the lens sheet L guided by the engaging portions 12 is transferred in a constant oblique condition. That is, the transfer distance of the lens sheet L is proportional to the displacement amount of the lens sheet L in the left or right direction. In this case, recording may be performed at the predetermined position by measuring the inclination angle formed by the guide direction of the engaging portions 12 and the predetermined transfer direction in advance and correcting recording image data for recording in accordance with the inclination angle even when the lens sheet L is transferred in an oblique direction.

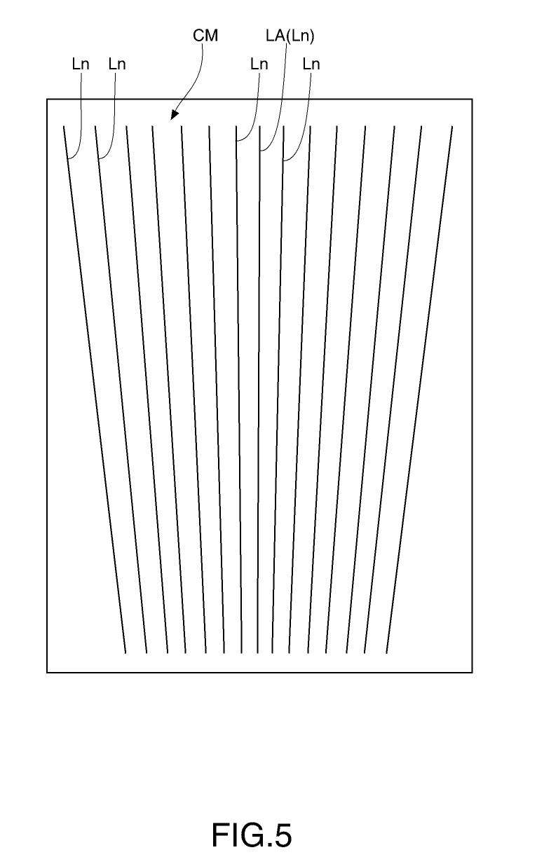

The inclination angle is measured by the following method. As illustrated in FIG. 5, an inspection image CM constituted by a plurality of lines Ln as an inspection image is recorded on the lens sheet L by the recording apparatus 300. These lines Ln contains a center line LA extending in the predetermined transfer direction on the image data, and other lines Ln sequentially inclined at the same angle in different directions and accumulated on the left and right sides with respect to the center line LA.

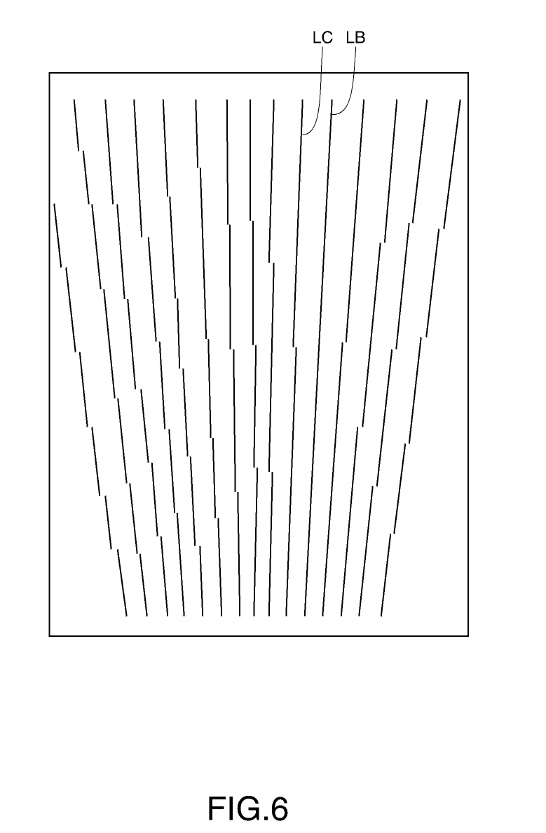

For example, the lines Ln on the right side of the line LA sequentially increase the inclination angles in increments of 0.01 degree clockwise in the transfer direction, and the lines Ln on the left side of the line LA sequentially increase the inclination angles in increments of 0.01 degree anticlockwise in the transfer direction. Based on the inspection image data thus produced, the inspection image CM is recorded on the lens sheet L transferred while guided by the engaging portions 12. When the inspection image CM recorded on the lens sheet L is viewed from the lenticular lens 7 side, a line LB contained in the lines Ln and recorded along the bus line (ridge line) of the lens element 13 of the lenticular lens 7 is visually recognized as a continuous line as illustrated in FIG. 6. On the other hand, the lines Ln not recorded along the bus lines (ridge lines) of the lens elements 13 lie across the plural lens elements 13. Thus, these lines are cut into parts divided to the right or left discontinuously such as a line LC.

Thus, the inclination angle of the line Ln corresponding to the line LB contained in the lins Ln and viewed as one line via the lenticular lens 7 is measured as the inclination angle formed by the guide direction of the engaging portions 12 and the predetermined transfer direction. Then, correction image data obtained by rotating the recording image data is produced based on the measured inclination angle. In this case, an image may be recorded at the predetermined position by recording the image on the lens sheet L based on the correction image data even when the lens sheet L is obliquely transferred.

According to this embodiment, the inclination angle of the guide direction of the engaging portions 12 is measured by using one type of inspection image on which lines are formed at inclination angles increasing in increments of 0.01 degree. However, the inclination angle of the guide direction of the engaging portions 12 may be measured by using two types of inspection image having different changes of the inclination angle. For example, a first inspection image on which lines are formed at inclination angles in increments of 0.05 degree is recorded on the lens sheet L to specify the line having the largest length of one line on the inspection image via the lenticular lens 7. Then, a second inspection image on which lines are formed at inclination angles in increments of 0.01 degree on the left and right sides of the inclination angle of the specified line is recorded on another lens sheet L to specify the line having the largest length of one line on the second inspection image via the lenticular lens 7. In this case, the inclination angle of this line is measured as the inclination angle formed by the guide direction of the engaging portions 12 and the predetermined transfer direction.

According to this method, the range of the inclination angle to be measured may be widened with increased accuracy in measurement by measuring the inclination angle of the guide direction of the engaging portions 12 using the two types of inspection image. More specifically, in case of the inspection image only containing lines at inclination angles in increments of 0.01 degree, the inclination angle is measured only in the range the number of times wider, which number is the number of the lines in increments of 0.01 degree on both sides of the center line. In case of two types of inspection image, however, the inclination angle in a wide range may be measured by using the inspection image containing lines at inclination angles in increments of 0.05 degree, and the inclination angle having higher accuracy may be measured by using the inspection image containing lines in increments of 0.01 degree. By increasing the types of inspection image, more accurate and wide-range transfer inclination angle measurement may be achieved.

### Fourth Embodiment

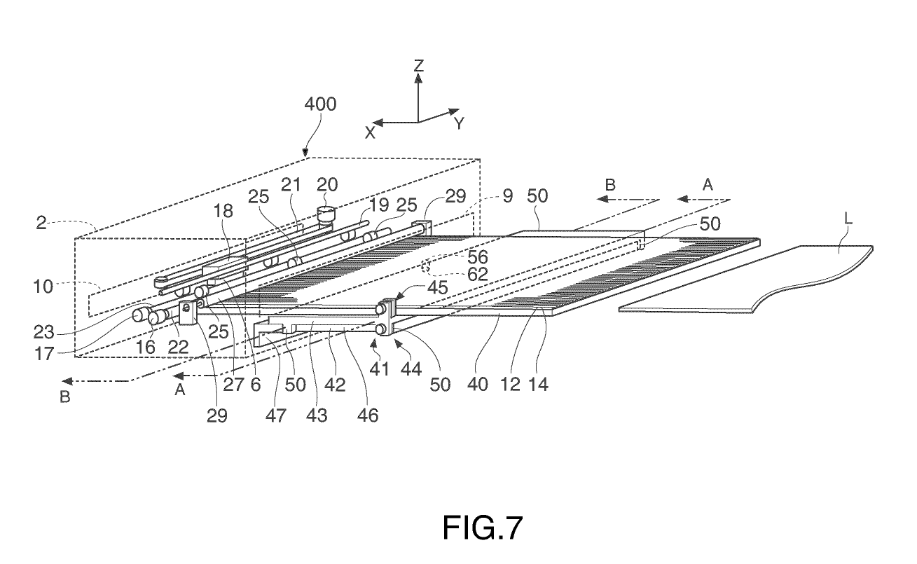

A recording apparatus 400 according to the fourth embodiment of the invention is now described with reference to FIGS. 7 through 9.

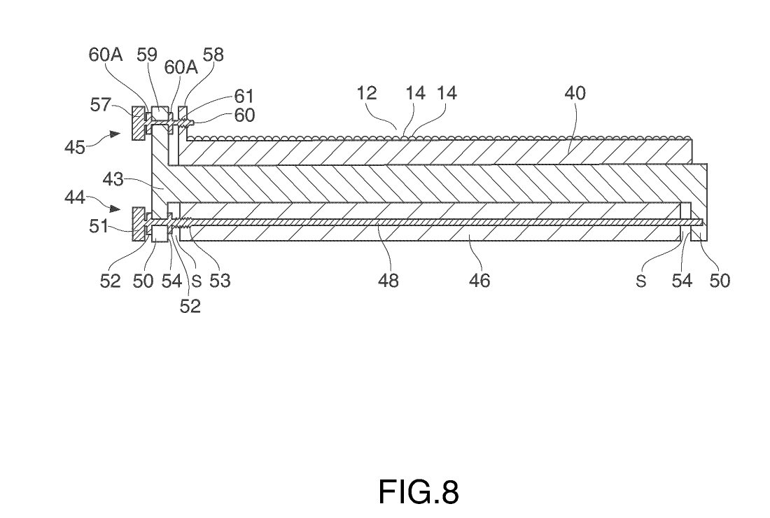

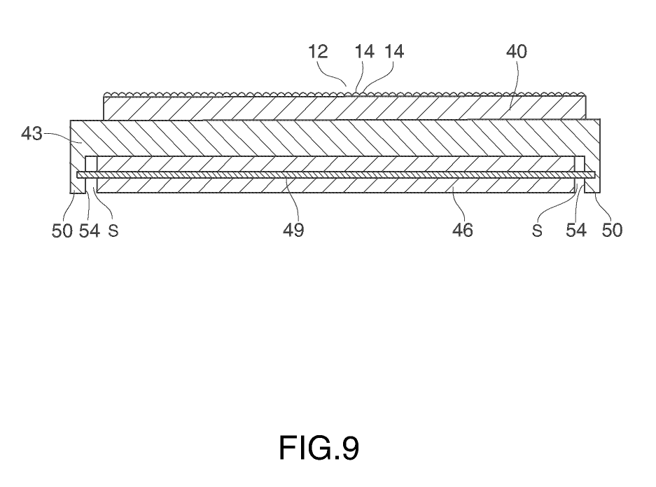

FIG. 7 is a perspective view schematically illustrating the structure of the recording apparatus 400 as viewed from the rear of the recording apparatus 400. FIG. 8 is a cross-sectional view taken along a line A-A in FIG. 7. FIG. 9 is a cross-sectional view taken along a lien B-B in FIG. 7. In these figures, reference numbers similar to those in the first through third embodiments are given to the similar parts, and the same explanation is not repeated.

The recording apparatus 400 in this embodiment has a sheet guide displacement mechanism 41 which performs displacement of a sheet guide 40 in the left and right directions and angle change with respect to the transfer direction of the lens sheet L. The sheet guide displacement mechanism 41 has a fixed stage 42 fixed to the housing 2 by screw or the like, a movable stage 43 movable in the left-right direction with respect to the fixed stage 42, a left-right displacement mechanism 44 as a displacement unit for displacing the movable stage 43 in the left-right direction with respect to the fixed stage 42, a rotation mechanism 45 as a rotation unit for rotating the sheet guide 40 mounted on the movable stage 43, and other components.

The fixed stage 42 has a plate-shaped stage plate 46 for carrying the movable stage 43, and a flange 47 formed under the front end of the stage plate 46. The fixed stage 42 is attached to the housing 2 as one piece by tightening the flange 47 to the housing 4 by screw or the like with the flange 47 contacting a lower position of the sheet feed opening 9 of the housing 2. The stage plate 46 is disposed to extend from the back of the housing 2 by fixing the flange 47 to the housing 2 in this condition.

The movable stage 43 is mounted on the upper surface of the stage plate 46. The movable stage 43 may be displaced in the left-right direction, that is, in the main scanning direction by the left-right displacement mechanism 44 having guide shafts 48 and 49 (see FIGS. 8 and 9) to be described later, tongue-shaped portions 50 formed on the movable stage 43, and other components. The movable stage 43 has a rectangular plate-shaped body as a whole, and tongue-shaped portions 50 extend downward from the vicinities of the four corners of the movable stage 43. The movable stage 43 is placed on the stage plate 46 such that the stage plate 46 is positioned inside the tongue-shaped portions 50.

As illustrated in FIG. 8, the cylindrical guide shaft is inserted through the rear region of the movable stage in the left-right direction. Both ends of the guide shaft are rotatably supported by a pair of the rear tongue-shaped portions 50. The left end of the guide shaft 48 penetrates through the tongue-shaped portion 50 to be connected to a control knob 51.

A pair of flanges 52 for pinching the tongue-shaped portion 50 from the left and the right are formed on the part of the guide shaft 48 penetrating through the tongue-shaped portion 50. Thus, movement of the guide shaft 48 rotatably supported by the tongue-shaped portion 50 is regulated by the two flanges 52 in the left-right direction. A screw connection portion 53 is formed on a part of the guide shaft 48 and a part of the movable stage 43. The guide shaft 48 inserted through the movable stage 43 allows the movable stage 43 to move along the guide shaft 48 in the area other than the screw connection portion 53.

As illustrated in FIG. 9, a cylindrical guide shaft 49 is inserted through the front region of the movable stage 43 in the left-right direction. Both ends of the guide shaft 49 are supported by a pair of the front tongue-shaped portions 50. The guide shaft 49 is inserted through the movable stage 43 such that the movable stage 43 may shift along the guide shaft 49.

When the control knob 51 of the left-right displacement mechanism 44 having this structure is rotated, the movable stage 43 is displaced in the left-right direction by the functions of the guide shaft 48, the movable stage 43, and the screw connection portion 53 according to the rotation direction of the control knob 51 while guided by the guide shaft 48 and the guide shaft 49. A clearance S allowing displacement of the movable stage 43 in the left-right direction is formed between inner side surfaces 54 of the left and right tongue-shaped portions 50 and side surfaces 55 of the stage plate 46.

The sheet guide 40 is placed on the upper surface of the movable stage 43. The sheet guide 40 may be rotated on the movable stage 43 around a rotation shaft 56 to be described later (see FIG. 7) by the rotation mechanism 45 having the rotation shaft 56, the control screw 57, and other components.

The sheet guide 40 has a structure similar to those of the sheet guides 3 and 26 in the first through third embodiments except in that one-sided portion 58 into which the control screw 57 is screwed is provided at the left edge of the sheet guide 40, and that the rotation shaft 56 is provided on the lower surface of the sheet guide 40. A screw bearing 59 for supporting the control screw 57 is provided on the movable stage 43 in such a position as to be opposed to the one-sided portion 58.

As illustrated in FIG. 8, the control screw 57 is rotatably inserted through the screw bearing 59 to be supported thereby, and flanges 60A are formed on a shaft 60 of the control screw 57 in such positions as to pinch the screw bearing 59 from the left and the right. Thus, the control screw 57 is rotatably supported by the screw bearing 59 in such a condition that shift of the control screw 57 in the left-right direction is regulated by the flanges 60A. A screw portion 61 formed at the end of the shaft 60 is screwed into the one-sided portion 58.

The rotation shaft 56 provided on the lower surface of the sheet guide 40 rotatably engages with a bearing 62 formed on the upper surface of the movable stage 43. The sheet guide 40 is rotatable on the movable stage 43 around the rotation shaft 56. When the control screw 57 of the rotation mechanism 45 having this structure is rotated, the sheet guide 40 having the one-sided portion 58 into which the screw 61 is screwed is rotated around the rotation shaft 56 in accordance with the rotation direction and rotation amount of the control screw 57.

For allowing the image recorded on the image forming layer 8 to be viewed as a predetermined image via the lenticular lens 7, the image corresponding to each lens element 13 needs to be recorded at the accurate position corresponding to the position of the lens element 13. It is thus necessary to match the position of the lenticular lens 7 with the recording position in the left-right direction, and to adjust the angle of the lenticular lens 7 of the lens sheet L with respect to the predetermined transfer direction to a predetermined angle.

Thus, the position of the lens sheet L placed on the sheet guide 40 is determined by controlling the displacement of the sheet guide 40 in the left-right direction and the rotation of the sheet guide 40 around the rotation shaft 56 such that recording may be performed at the predetermined position of the lenticular lens 7 by using the sheet guide displacement mechanism 41.

For controlling the displacement in the left-right direction and the rotation of the sheet guide 40, the rotation position of the sheet guide 40 is controlled by rotating the control knob 51 such that the center line of the inspection image (line LA shown in FIG. 5) is viewed as one line when the lens sheet L containing the inspection image recorded thereon is viewed from the lenticular lens 7 side.

The recording position of the image on the lens sheet L needs to be located at a predetermined position with respect to the lens elements 13 of the lenticular lens 7 by controlling the position in the left-right direction as well as the inclination angle to the transfer direction of the lens sheet L. The position of the lens sheet L in the left-right direction may be disposed at the predetermined position with respect to the recording position of the image by displacing the sheet guide 40 in the left-right direction by using the control knob 51.

Accordingly, the recording position of the image with respect to the lens sheet L may be easily disposed at the predetermined position by using the sheet guide displacement mechanism 41.

### Fifth Embodiment

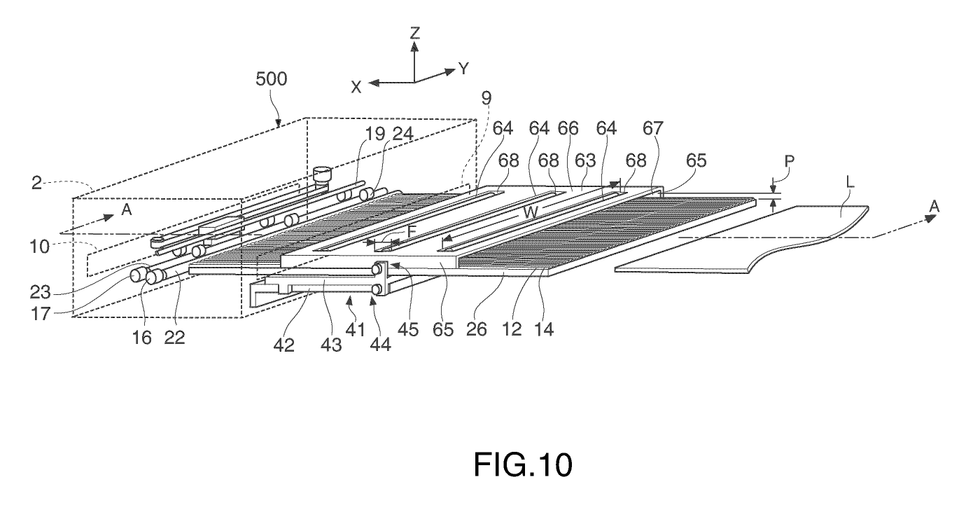

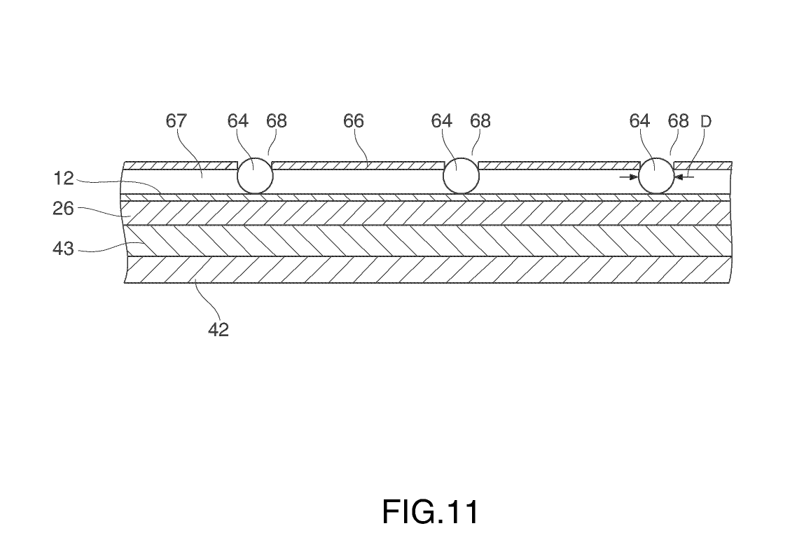

A recording apparatus 500 according to a fifth embodiment of the invention is now described with reference to FIGS. 10 and 11.

FIG. 10 is a perspective view schematically illustrating the structure of the recording apparatus 500 as viewed from the rear of the recording apparatus 500. FIG. 11 is a cross-sectional view taken along a line A-A in FIG. 10. In these figures, reference numbers similar to those in the first through fourth embodiments are given to the similar parts, and the same explanation is not repeated.

According to the recording apparatus 500 in this embodiment, a frame 63 is attached to the upper surface of the sheet guide 26, and a plurality of weighing rollers 64 (three in this embodiment) are holded on the frame 63. Similarly to the weighing roller 27 of the recording apparatus 200, the weighing roller 64 is made of metal such as stainless steel and brass, and has a length larger than the width of the lens sheet L in the left-right direction.

The frame 63 has legs 65 attached to the left and right edges of the sheet guide 26, and a plate-shaped body 66 supported by the left and right legs 65 at a position above the sheet guide 26 to form a tunnel 67 extending through the frame 63 in the front-rear direction. Rectangular holes 68 extending in the left-right direction are formed on the plate-shaped body 66. The number of the holes 68 is three in correspondence with the number of the weighing rollers 64. Each width W of the holes 68 in the left-right direction is larger than each length of the weighing rollers 64. Each of a length F of the holes 68 in the front-rear direction and a clearance P between the engaging portions 12 and the plate-shaped body 66 is shorter than a diameter D of the weighing rollers 64. In the arrangement where the weighing rollers 64 are disposed under the holes 68, the weighing rollers 64 are holded by the frame 63 with the shifts of the weighing rollers 64 in the front-rear and left-right directions regulated by the holes 68.

The length F of the holes 68 in the front-rear direction and the clearance P between the engaging portions 12 and the plate-shaped body 66 are set at a length and a clearance sufficient for the shifts of the weighing rollers 64 at least for a distance longer than the thickness of the lens sheet L in the up-down direction. In this case, the lens sheet L may be inserted into the tunnel 67 from a rear opening 69 of the tunnel 67 such that the lens sheet L may enter between the weighing rollers 64 and the engaging portions 12.

The lens sheet L inserted between the weighing rollers 64 and the engaging portions 12 is pressed against the sheet guide 26 by the weight of the weighing rollers 64. The shifts of the weighing rollers 64 toward the front are regulated by the holes 68. When the lens sheet L is transferred toward the front by the sheet feed rollers 22 and the sheet discharge roller 23, the weighing rollers 64 revolve inside the holes 68 by following the transfer of the lens sheet L. Thus, the lens sheet L may be pressed against the sheet guide 26 while preventing increase in the transfer load of the lens sheet L. Moreover, the lens sheet L may be transferred without rubbing against the weighing rollers 64.

Similarly to the recording apparatuses 100 through 400, the lens sheet L placed on the recording apparatus 500 is transferred with its transfer direction kept constant in the guide direction of the engaging portions 12. Thus, recording by the recording head 6 may be performed at the predetermined position. Also, engagement between the lenticular lens 7 and the engaging portions 12 is secured by pressing the lens sheet L against the sheet guide 26 using the weighing rollers 64. Thus, accuracy in the recording position on the lens sheet L may be more increased. In this embodiment, the three weighing rollers 64 are disposed in the front-rear direction. In this arrangement, a wide range of the lens sheet L may be pressed, allowing securer engagement between the lenticular lens 7 and the engaging portions 12. The screw 61 of the control knob 51 is screwed into the left leg 65 such that the sheet guide 26 may be rotated by rotating the control knob 51.

### Sixth Embodiment

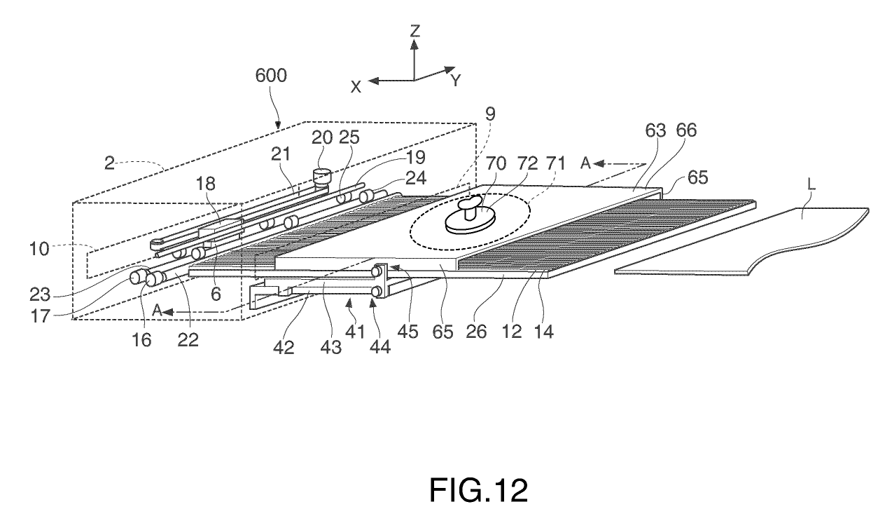

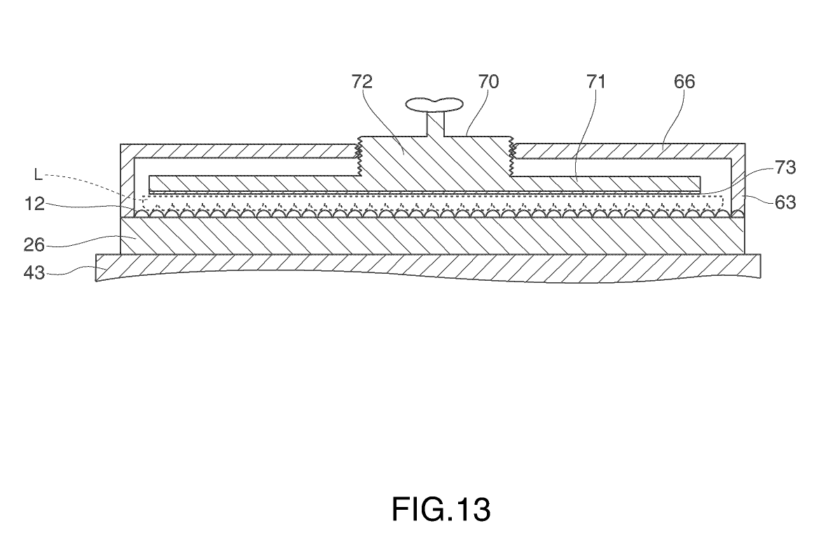

A recording apparatus 600 according to a sixth embodiment of the invention is now described with reference to FIGS. 12 and 13.

FIG. 12 is a perspective view schematically illustrating the structure of the recording apparatus 600 as viewed from the rear of the recording apparatus 600. FIG. 13 is a cross-sectional view taken along a line A-A in FIG. 12. In these figures, reference numbers similar to those in the first through fifth embodiments are given to the similar parts, and the same explanation is not repeated.

According to the recording apparatus 600 in this embodiment, the lens sheet L is pressed against the engaging portions 12 by using a pressing member 70 instead of the weighing rollers 64. The pressing member 70 has a circular pressing plate 71, and a screw 72 provided on the upper surface of the pressing plate 71. Felt 73 is affixed to the lower surface of the pressing plate 71.

The screw 72 is screwed into the plate-shaped body 66, and the pressing member 70 may be displaced upward and downward with respect to the plate-shaped body 66 by rotation around the screw 72. In this structure, the lens sheet L may be pressed against the engaging portions 12 by the pressing plate 71 using reaction force when the pressing member 70 is rotated around the screw 72 and displaced downward. As a result, the engagement between the lenticular lens 7 and the engaging portions 12 is secured, and accuracy in the recording position on the lens sheet L is increased. Since the pressing plate 71 is pressed against the lens sheet L via the felt 73, large resistance is not produced during transfer of the lens sheet L.

### Seventh Embodiment

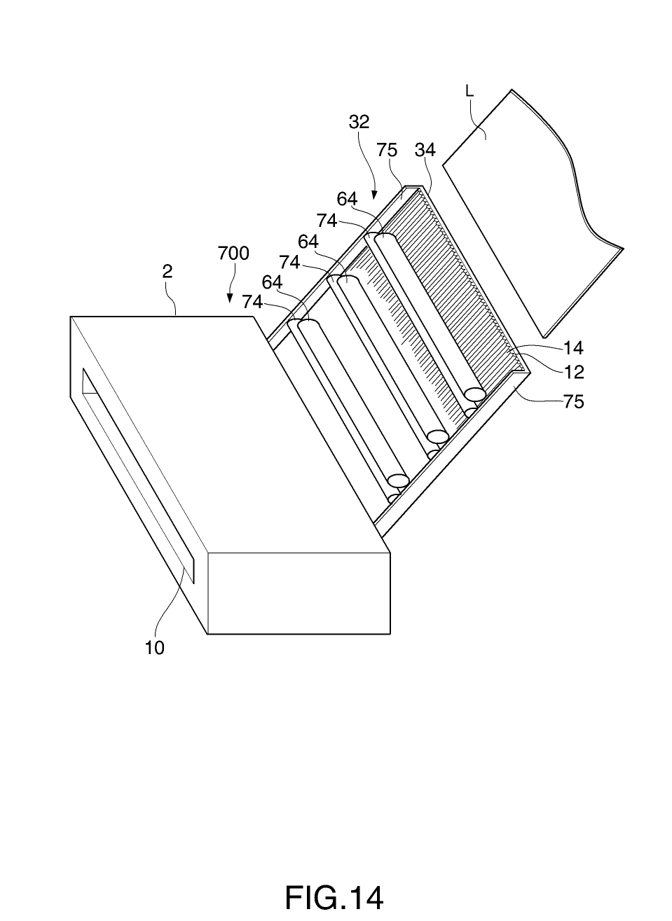

A recording apparatus 700 according to a seventh embodiment of the invention is now described with reference to FIG. 14.

FIG. 14 is a perspective view schematically illustrating the structure of the recording apparatus 700 as viewed from the rear of the recording apparatus 700. In this figure, reference numbers similar to those in the first through sixth embodiments are given to the similar parts, and the same explanation is not repeated.

According to the recording apparatus 700 in this embodiment, the weighing rollers 64 and the engaging portions 12 are provided on the sheet stacker 34 of the sheet feeder mechanism 32, and the lens sheet L placed on the sheet stacker 34 is transferred while guided by the engaging portions 12. The components such as the sheet weights 33 and the pickup roller 35 have structures similar to those of the recording apparatus 300 in the third embodiment.

The engaging portions 12 are produced by affixing the lens sheet L to the bottom surface (surface on which sheet is placed) of the sheet stacker 34 with the lenticular lens 7 facing above or by other methods. The weighing rollers 64 are disposed at three positions in the front-rear direction, and supported by roller stops 74 which prevent downward rolling of the weighing rollers 64 toward the front. The roller stops 74 are attached to a side wall plate 75 standing upward at the left and right edges of the sheet stacker 34 for the respective weighing roller 64. The roller stops 74 have cylindrical shapes, and a clearance sufficient for preventing contact between the lens sheet L and the roller stops 74 when the lens sheet L passes is provided between the lower portions of the roller stops 74 and the engaging portions 12.

For recording on the lens sheet L by using the sheet feeder mechanism 32, the lens sheet L is initially inserted between the roller stops 74 and the engaging portions 12 from the rear with the lenticular lens 7 side surface of the lens sheet L facing the engaging portions 12 before placed on the sheet stacker 34. Then, the lens sheet L is shifted toward the front until a position where the lens sheet L may receive transferring force of the pickup roller 35 (see FIG. 4) or the sheet feed roller 4 (see FIG. 4). Subsequently, the weighing rollers 64 are placed on the lens sheet L positioned on the sheet stacker 34 disposed behind the roller stops 74. The lens sheet L is pressed by the engaging portions 12 when the weighing rollers 64 are placed on the lens sheet L. During transfer of the lens sheet L, the lens sheet L is guided by the engaging portions 12 in the left-right direction, and the transfer direction is kept constant. Thus, recording on the lens sheet L by the recording head 6 may be performed at a predetermined position. Moreover, the engagement between the lenticular lens 7 and the engaging portions 12 is secured by pressing the lens sheet L against the engaging portions 12 using the weighing rollers 64, and therefore accuracy in the recording position on the lens sheet L may be increased.

### Eighth Embodiment

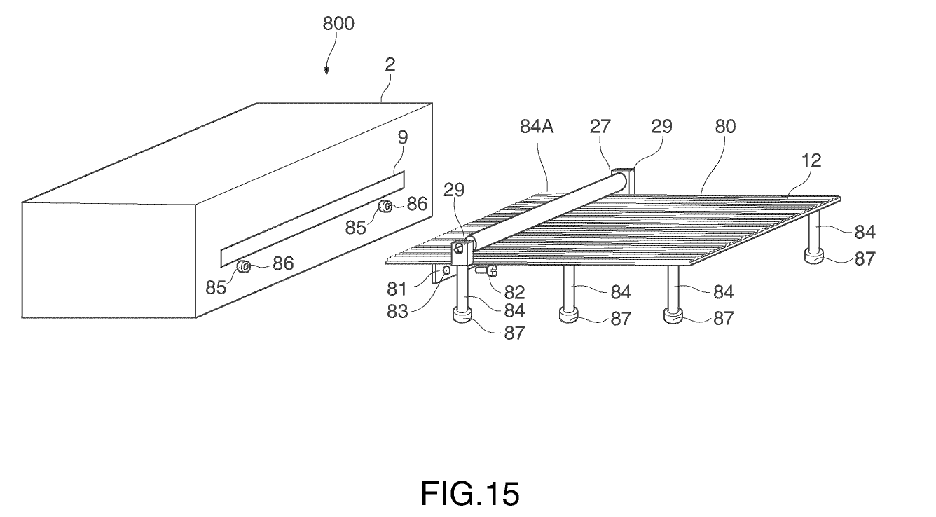

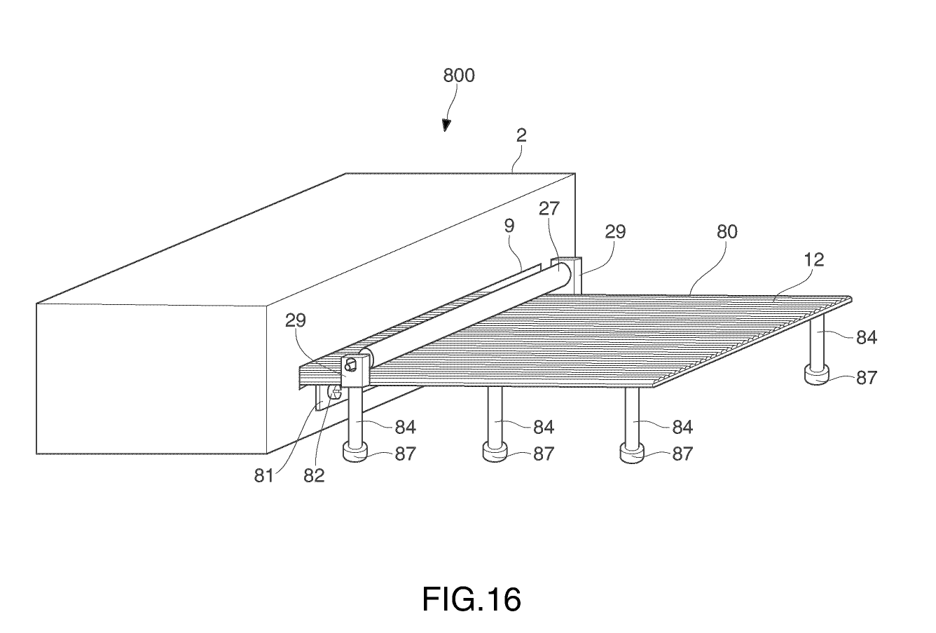

A recording apparatus 800 according to an eighth embodiment of the invention is now described with reference to FIGS. 15 and 16. In these figures, reference numbers similar to those in the first through sixth embodiments are given to the similar parts, and the same explanation is not repeated.

While the sheet guide 3 (26) is fixed to the housing 2 in the recording apparatus 100 or others, a sheet guide 80 of the recording apparatus 800 is detachably attached to the housing 2. FIG. 15 illustrates the condition in which the sheet guide 80 is removed from the housing 2. FIG. 16 illustrates the condition in which the sheet guide 80 is attached to the housing 2.

A tongue-shaped portion 81 extending below is provided on the lower surface of the sheet guide 80. The tongue-shaped portion 81 extends through almost the entire width of the sheet guide 80 in the left-right direction. Screw insertion holes 83 through which attachment screws 82 are inserted are provided at the left and right ends of the tongue-shaped portion 81 (right screw insertion hole 83 is not shown since it is located below the sheet guide 80). Three support legs 84 for supporting the sheet guide 80 on an installation surface or the like are provided on each of the left and right sides of the lower surface of the sheet guide 80. Cylindrically projecting sheet guide support projections 85 for receiving the tongue-shaped portion 81 are provided on the rear side surface of the housing 2. Screw holes 86 into which the attachment screws 82 are screwed are formed at the centers of the sheet guide supporting projections 85. The sheet guide 80 is attached to the housing 2 by screwing the attachment screws 82 into the screw holes 86 with the tongue-shaped portion 81 contacting end surfaces 85A of the sheet guide support projections 85.

The sheet guide 80 has an extension 80A before the tongue-shaped portion 81. The extension 80A is disposed in such a position as to be inserted into the housing 2 through the sheet feed opening 9 with the sheet guide 80 attached to the housing 2, that is, with the tongue-shaped portion 81 attached to the sheet guide support projections 85. The extension length of the extension 80A from the tongue-shaped portion 81 is determined such that the front end of the extension 80A is disposed before the sheet feed roller 22 (not shown).

Grounding portions 87 provided at the lower ends of the six support legs 84 are attached to the support legs 84 via not-shown screw connections, and are movable in the up-down direction of the support legs 84 by controlling the amount of screw connection. More specifically, the height of the sheet guide 80 may be controlled by changing the amount of screw connection between the grounding portions 87 and the support legs 84. Also, inclination of the sheet guide 80 in the front-rear and left-right directions by changing the amount of screw connection between each pair of the support leg 84 and the grounding portion 87 relative to each other. Thus, the sheet guide 80 is controlled such that the upper surface of the sheet guide 80 is in the flat condition, that is, the upper surface coincides with the height of the lens sheet L (not shown) to be transferred by the sheet feed roller 22 and the sheet discharge roller 23 by controlling the amount of screw connection between the grounding portions 87 and the support legs 84 at the time of fixing the extension 80A to the sheet guide support projections 85 via the attachment screws 82.

The weighing roller 27 provided on the upper surface of the sheet guide 80 is supported by the bearing 29. Thus, the lens sheet L placed on the sheet guide 80 is pressed against the sheet guide 80 by the weighing roller 27. Accordingly, engagement between the engaging portions 12 and the lenticular lens 7 is secured, and transfer accuracy of the lens sheet L (not shown) in the left-right direction, that is, straightness in transfer of the lens sheet L (not shown) are increased.

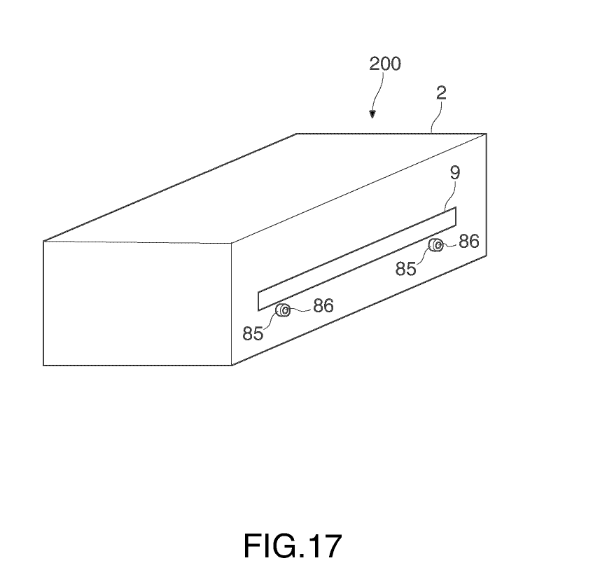

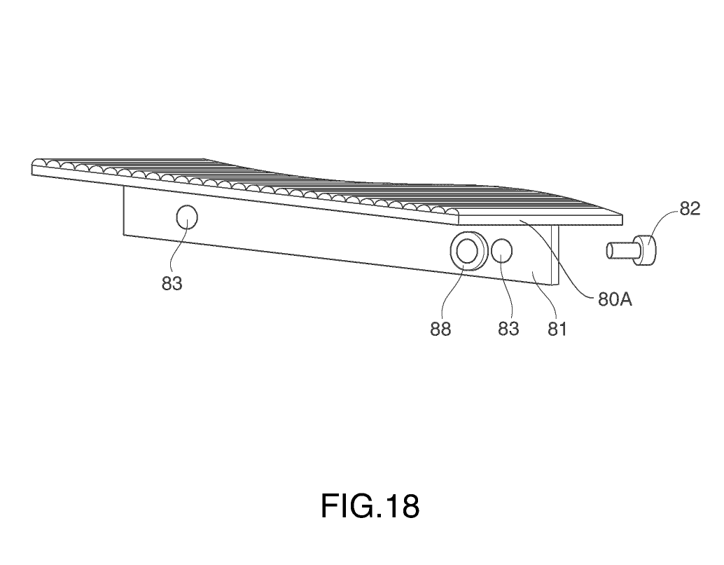

It is preferable that the sheet guide 80 is attached to the housing 2 such that the guide direction of the engaging portions 12 accurately agrees with the predetermined transfer direction of the lens sheet L (not shown), that is, the guide direction of the engaging portions 12 is orthogonal to the main scanning direction (direction orthogonal to the sheet feed roller 22 and the sheet discharge roller 23 (not shown)). In this case, inclination of the sheet guide 80 in the left-right direction may be eliminated by differing the respective heights of the cylindrical portions of the left and right sheet guide support projections 85 as illustrated in FIG. 17, or inclination in the left-right direction at the time of attaching the sheet guide 80 to the housing 2 may be eliminated by providing a washer 88 as a spacer between the tongue-shaped portion 81 and the sheet guide support projections 85 as illustrated in FIG. 18. When the inclination of the sheet guide 80 in the left-right direction is eliminated by using the washer 88, the washer 88 having an adequate thickness for eliminating the inclination is provided on either the left or the right side, or the washer 88 having different thicknesses for eliminating the inclination are provided on the left and right sides.

According to the recording apparatus 800 having this structure, the sheet guide 80 may be easily attached to the housing 2.

While the engaging portions 12 are provided throughout the width of the lens sheet L in the left-right direction in the respective embodiments, the engaging portions may be constituted by at least one or a plurality of the linear convexes 14. When the engaging portions 12 are formed by the plural linear convexes 14, the interval between the linear convexes 14 is a distance equivalent to an integral number times longer than the arrangement pitch of the lenticular lens 7. In this case, all of the plural convexes 14 positioned below the lens sheet L may engage with the lenticular lens 7, and therefore the engagement between the lenticular lens 7 and the engaging portions 12 may be secured.

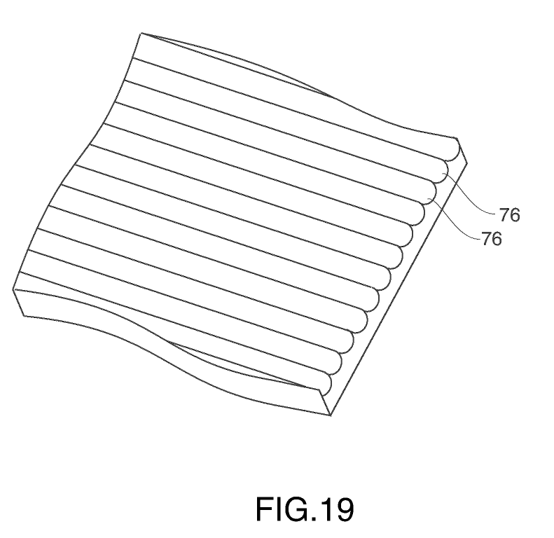

While the engaging portions 12 are constituted by the linear convexes 14 in the respective embodiments, the engaging portions may be linear concaves 76 having shape similar to that of the lenticular lens 7 as illustrated in FIG. 19.

The surface of the engaging portions 12 maybe coated with low-frictional material such as fluororesin to reduce friction between the lens sheet L and the engaging portions 12 and transfer the lens sheet L more smoothly. In this case, abrasion resistance of the engaging portions 12 may improve. The friction between the lens sheet L and the engaging portions 12 may be further decreased by coating the lenticular lens 7 side with transparent low-frictional material. In this case, transfer of the lens sheet L may be smoothly achieved.

According to the recording apparatus 100 and the like in the respective embodiments, the recording head 6 shifts in the direction perpendicular to the transfer direction of the lens sheet L. However, the recording apparatuses of the invention are applicable to a recording apparatus of the type which uses not a movable recording head but a so-called line head. In this case, the main scanning direction as the moving direction of the recording head 6 corresponds to the longitudinal direction of the line head.

In the respective embodiments, a thin sheet medium such as copy sheet instead of the lens sheet L as a transfer target may be easily transferred in the guide direction of the engaging portions 12 by pressing the sheet medium against the engaging portions 12 using the pressing unit such as the sheet feed roller 4 and the sheet discharge roller 5, or the pressing unit of the weighing rollers 27. Thus, the transfer accuracy in the left-right direction at the time of transfer of the sheet medium, that is, the straightness in transfer of the paper medium may be increased.

The entire disclosure of Japanese Patent Application No. 2007-246677, filed Sep. 25, 2007 is expressly incorporated by reference herein.

What is claimed is:

1. A recording apparatus which transfers a recording medium having a lenticular lens and performs recording on the recording medium to be transferred, comprising:
a linear engaging portion disposed on a supporting surface of a supporting unit for supporting the recording medium to be transferred to engage with the lenticular lens in a predetermined transfer direction.

2. The recording apparatus according to claim 1, wherein the number of the engaging portion is plural and an integral number times larger than the arrangement pitch of the lenticular lens.

3. The recording apparatus according to claim 2, wherein the engaging portions are formed throughout the recording medium in the width direction of the recording medium with the same pitch as that of the lenticular lens.

4. The recording apparatus according to claim 1, further comprising a pressing unit which presses the recording medium against the support surface.

5. The recording apparatus according to claim 4, wherein the pressing unit is a rotation roller which rotates in the transfer direction of the recording medium.

6. The recording apparatus according to claim 1, further comprising a displacement mechanism which displaces the engaging portion in a direction perpendicular to the transfer direction along the supporting surface.

7. The recording apparatus according to claim 1, further comprising a rotation mechanism which rotates the engaging portion along the supporting surface.

8. The recording apparatus according to claim 1, wherein the engaging portion is formed by the same component as that of the lenticular lens of the recording medium.
